(19) United States
(12) Patent Application Publication
(10) Pub. No.: US 2016/0225349 A1
(43) Pub. Date: Aug. 4, 2016

(54) METHOD OF COMPENSATING AN IMAGE OF A DISPLAY DEVICE, AND DISPLAY DEVICE

(71) Applicant: Samsung Display Co., Ltd., Yongin-City (KR)

(72) Inventors: Min-Tak LEE, Seongnam-si (KR); Jung-Kook Park, Cheonan-si (KR)

(21) Appl. No.: 14/750,922

(22) Filed: Jun. 25, 2015

(30) Foreign Application Priority Data
Feb. 3, 2015 (KR) 10-2015-0016519

(51) Int. Cl. G09G 5/34; G06T 5/00; G06F 3/0488; G06F 3/041; G06F 3/0485

(52) U.S. Cl. CPC G09G 5/34; G06F 3/0416; G06F 3/0485; G06F 3/04883; G06T 5/006

(57) ABSTRACT

A method of compensating an image of a display device is disclosed. In one aspect, the method includes obtaining a scroll speed of the image displayed in the display device that sequentially drives a plurality of pixels in a scanning direction from a first scan line to a second scan line. The method further includes shifting image data for the pixels by a shift amount, the shift amount being substantially proportional to the scroll speed and gradually increasing along the scanning direction.

### INCORPORATION BY REFERENCE TO ANY PRIORITY APPLICATIONS

This application claims priority under 35 USC §119 to Korean Patent Applications No. 10-2015-0016519, filed on Feb. 3, 2015 in the Korean Intellectual Property Office (KIPO), the contents of which are incorporated herein in its entirety by reference.

### BACKGROUND

1. Field

The described technology generally relates to a display device.

2. Description of the Related Technology

In a progressive type display device where the display device sequentially display an image from a first group of pixels connected to the first scan line to a last group of pixels connected to the last scan line, a start time point of a display period of the last group of pixels is delayed by about one frame period with respect to a start time point of a display period of the first group of pixels.

### SUMMARY OF CERTAIN INVENTIVE ASPECTS

One inventive aspect relates to a display device and method of compensating an image to be displayed on the display device

Another aspect is a method of compensating an image of a display device capable of preventing an image distortion caused by an image scroll.

Another aspect is a display device capable of preventing an image distortion caused by an image scroll.

Another aspect is a method of compensating an image of a display device that sequentially drives a plurality of pixels in a scanning direction from a first scan line to a second scan line, a scroll speed of the image displayed by the display device is obtained, and image data for the pixels are shifted by a shift amount that is proportional to the scroll speed and is gradually increased along the scanning direction.

In some example embodiments, the shift amount of the image data for the pixels connected to the second scan line may be greater than the shift amount of the image data for the pixels connected to the first scan line.

In some example embodiments, the image data may be shifted in a direction the same as the scanning direction.

In some example embodiments, the scroll speed of the image may be converted into a number of pixels per frame.

In some example embodiments, the shift amount of the image data for the pixels connected to a last scan line may correspond to the number of pixels per frame.

In some example embodiments, to shift the image data, the image displayed by the display device may be equally divided into a plurality of regions such that a number of the regions equals the number of pixels per frame, and the image data may be shifted by increasing the shift amount by one pixel per each of the regions along the scanning direction.

In some example embodiments, the scroll speed may be measured by comparing the image data of a previous frame and the image data of a current frame.

In some example embodiments, a scroll input may be recognized by a user.

In some example embodiments, the scroll speed may be measured during a predetermined time from a time point when the scroll input is recognized.

In some example embodiments, the scroll input may be recognized by a touch controlled included in the display device.

In some example embodiments, the scroll speed may be obtained based on scroll speed information provided from a host device that controls the display device.

Another aspect is a display device including a display panel including a plurality of pixels, a scan driving unit configured to sequentially provide a scan signal to the pixels in a scanning direction from a first scan line to a second scan line, a scroll speed measuring unit configured to measure a scroll speed of an image displayed at the display panel, a data shifting unit configured to shift image data for the pixels by a shift amount, the shift amount being proportional to the scroll speed and being gradually increased along the scanning direction, and a data driving unit configured to drive the pixels based on the shifted image data.

In some example embodiments, the shift amount of the image data for the pixels connected to the second scan line may be greater than the shift amount of the image data for the pixels connected to the first scan line.

In some example embodiments, the scroll speed measuring unit may measure the scroll speed by comparing the image data of a previous frame and the image data of a current frame.

In some example embodiments, the data shifting unit may shift the image data in a direction the same as the scanning direction.

In some example embodiments, the data shifting unit may convert the scroll speed of the image into a number of pixels per frame, may equally divide the image displayed at the display panel into a plurality of regions such that a number of the regions equals the number of pixels per frame, and may shift the image data by increasing the shift amount by one pixel per each of the regions along the scanning direction.

In some example embodiments, the display device may further include touch sensors configured to detect a touch input by a user, and a touch controller configured to control the touch sensors, the touch controller including a scroll recognizing unit that determines whether the touch input detected by the touch sensors corresponds to a scroll input.

In some example embodiments, the scroll speed measuring unit may measure the scroll speed during a predetermined time from a time point when the scroll recognizing unit recognizes the scroll input.

In some example embodiments, the scroll speed measuring unit may initiate an operation that measures the scroll speed in response to a scroll notification signal received from a host device.

Another aspect is a display device including a display panel including a plurality of pixels, a scan driving unit configured to sequentially provide a scan signal to the pixels in a scanning direction from a first scan line to a second scan line, a data shifting unit configured to receive scroll speed information representing a scroll speed of an image displayed at the display panel, and to shift image data for the pixels by a shift amount, the shift amount being proportional to the scroll speed and being gradually increased along the scanning direction, and a data driving unit configured to drive the pixels based on the shifted image data.

Another aspect is a method of compensating an image on a display device, the method comprising: obtaining a scroll speed of the image displayed by the display device that sequentially drives a plurality of pixels in a scanning direction from a first scan line to a second scan line; and shifting image data for the pixels by a shift amount, the shift amount being substantially proportional to the scroll speed and gradually increasing along the scanning direction.

In the above method, the shift amount of the image data for a first group of the pixels connected to the first scan line is less than the shift amount of the image data for a second group of the pixels connected to the second scan line. In the above method, the image data are shifted in a direction the same as the scanning direction. The above method further comprises converting the scroll speed of the image into a number of pixels per frame. In the above method, the shift amount of the image data for a third group of the pixels connected to a last scan line corresponds to the number of pixels per frame. In the above method, the shifting comprises: equally dividing the image displayed in the display device into a plurality of regions such that the number of the regions equals the number of pixels per frame; and increasing the shift amount by one pixel per each of the regions along the scanning direction so as to shift the image data.

In the above method, the scroll speed is measured by comparing the image data of a previous frame and the image data of a current frame. The above method further comprises recognizing a scroll input by a user. In the above method, the scroll speed is measured during a predetermined time from a time point when the scroll input is recognized. In the above method, the scroll input is recognized by a touch controller included in the display device. In the above method, the scroll speed is obtained based on scroll speed information provided from a host device that controls the display device.

Another aspect is a display device, comprising: a display panel including a plurality of pixels; a scan driver configured to sequentially provide a scan signal to the pixels in a scanning direction from a first scan line to a second scan line; a scroll speed measuring unit configured to measure a scroll speed of an image displayed in the display panel; a data shifter configured to shift image data for the pixels by a shift amount, the shift amount being substantially proportional to the scroll speed and gradually increasing along the scanning direction; and a data driver configured to drive the pixels based on the shifted image data.

In the above display device, the shift amount of the image data for a first group of the pixels connected to the first scan line is less than the shift amount of the image data for a second group of the pixels connected to the second scan line. In the above display device, the scroll speed measuring unit is further configured to measure the scroll speed based on the comparison of the image data of a previous frame and the image data of a current frame. In the above display device, the data shifter is further configured to shift the image data in a direction the same as the scanning direction. In the above display device, the data shifter is further configured to i) convert the scroll speed of the image into a number of pixels per frame, ii) equally divide the image displayed in the display panel into a plurality of regions such that the number of the regions equals the number of pixels per frame, and iii) increase the shift amount by one pixel per each of the regions along the scanning direction so as to shift the image.

The above display device further comprises: a plurality of touch sensors configured to detect a touch input by a user; and a touch controller configured to control the touch sensors, the touch controller including a scroll recognizer configured to determine whether the touch input detected by the touch sensors corresponds to a scroll input. In the above display device, the scroll speed measuring unit is further configured to measure the scroll speed during a predetermined time from a time point when the scroll recognizer recognizes the scroll input. In the above display device, the scroll speed measuring unit is further configured to initiate an operation that measures the scroll speed in response to a scroll notification signal received from a host device.

Another aspect is a display device, comprising: a display panel including a plurality of pixels; a scan driver configured to sequentially provide a scan signal to the pixels in a scanning direction from a first scan line to a second scan line; a data shifter configured to receive scroll speed information representing a scroll speed of an image displayed in the display panel, and to shift image data for the pixels by a shift amount, the shift amount being substantially proportional to the scroll speed and gradually increasing along the scanning direction; and a data driver configured to drive the pixels based on the shifted image data.

At least one of the disclosed embodiments can shift the image data by the shift amount in proportion to the scroll speed while gradually increasing the shift amount along the scanning direction, thereby preventing the image distortion caused by the image scroll.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of compensating an image of a display device according to example embodiments.

FIG. 2 is a block diagram illustrating a display device according to example embodiments.

FIG. 3 is a diagram illustrating frame periods of a display device according to example embodiments.

FIG. 4 is a diagram illustrating an example of a still image displayed by a display device in accordance with example embodiments.

FIG. 5A is a diagram for describing an example where an image distortion occurs in a typical display device when an image is scrolled, and FIG. 5B is a diagram for describing an example of a data shift operation performed by a display device according to example embodiments.

FIG. 6A is a diagram for describing another example where an image distortion occurs in a typical display device when an image is scrolled, and FIG. 6B is a diagram for describing another example of a data shift operation performed by a display device according to example embodiments.

FIG. 7 is a flow chart illustrating a method of compensating an image of a display device according to example embodiments.

FIG. 8 is a block diagram illustrating a display device according to example embodiments.

FIG. 9 is a diagram for describing a method of measuring a scroll speed in a display device according to example embodiments.

FIG. 10 is a diagram for describing an example of a data shift operation performed by a display device according to example embodiments.

FIG. 11 is a flow chart illustrating a method of compensating an image of a display device according to example embodiments.

FIG. 12 is a block diagram illustrating a display device according to example embodiments.

FIG. 13 is a flow chart illustrating a method of compensating an image of a display device according to example embodiments.

FIG. 14 is a block diagram illustrating a display device according to example embodiments.

FIG. 15 is a block diagram illustrating an electronic device including a display device in accordance with example embodiments.

### DETAILED DESCRIPTION OF CERTAIN INVENTIVE EMBODIMENTS

When an image is scrolled in the progressive type display device, the image may be distorted due to the display start time differences, among relative pixel group locations on the screen.

The example embodiments are described more fully hereinafter with reference to the accompanying drawings. Like or similar reference numerals refer to like or similar elements throughout.

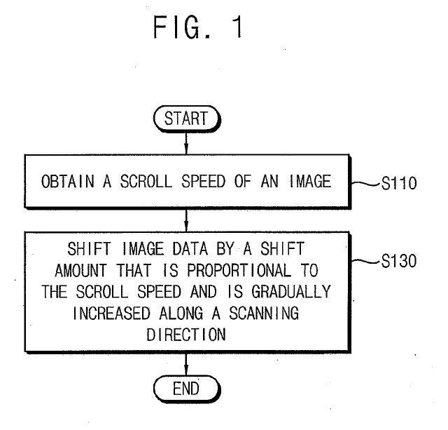

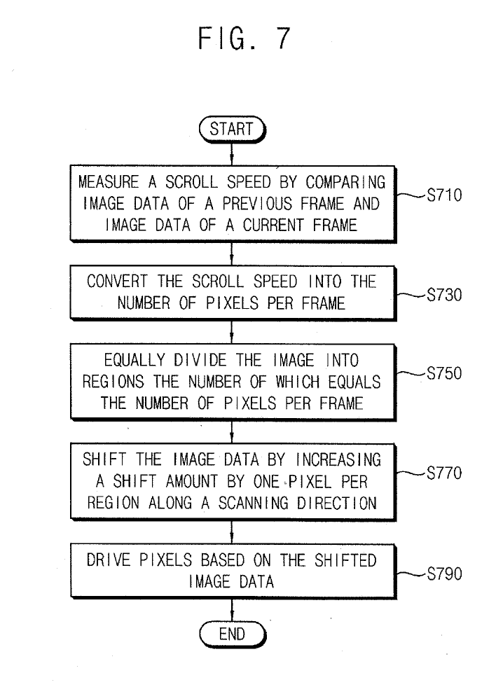

FIG. 1 is a flow chart illustrating a method of compensating an image of a display device according to example embodiments In some embodiments, the FIG. 1 procedure is implemented in a conventional programming language, such as C or C++ or another suitable programming language. The program can be stored on a computer accessible storage medium of the display device 200. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9×/ME/XP, Macintosh OS, OS X, OS/2, Android, iOS and the like. In another embodiment, at least part of the procedure can be implemented with embedded software. Depending on the embodiments, additional states can be added, others removed, or the order of the states changed in FIG. 1. This applies to the procedures shown in FIGS. 7, 11 and 13.

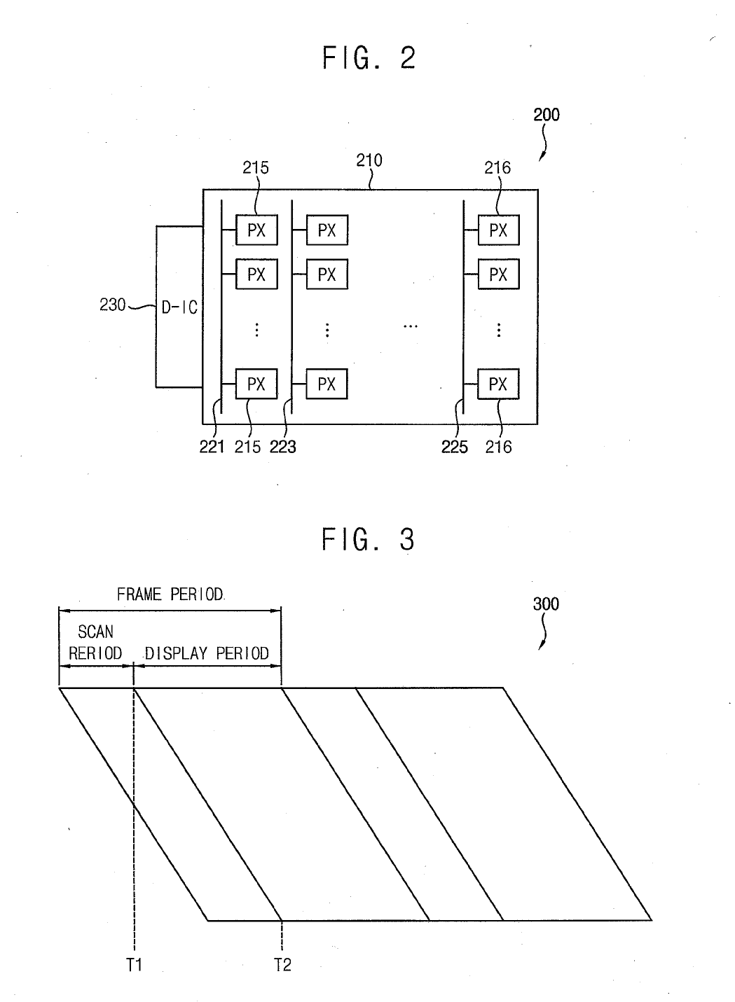

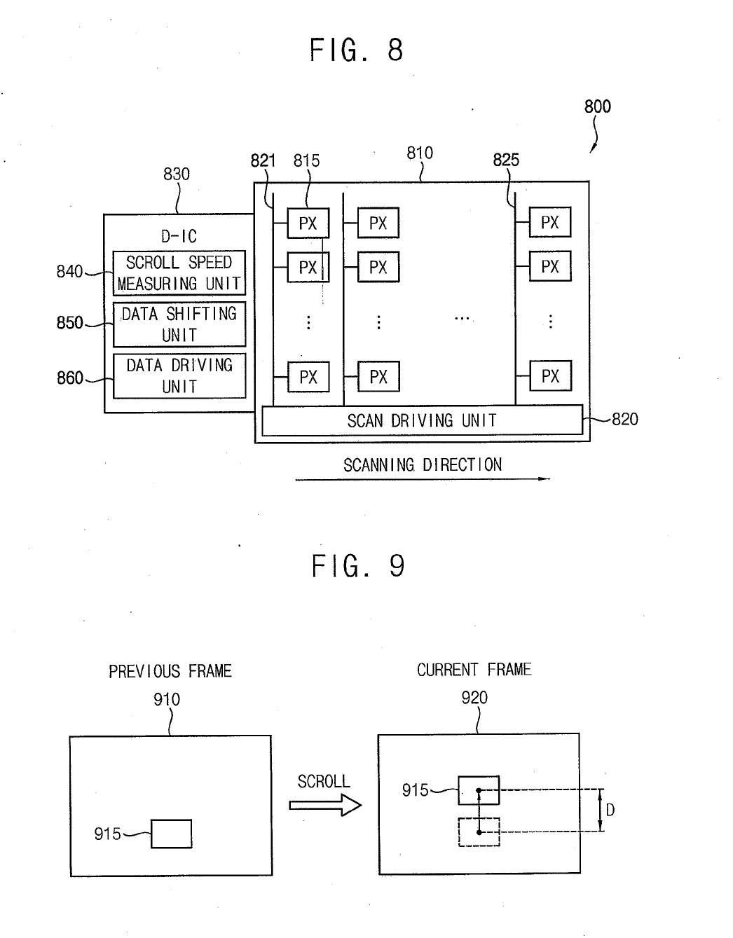

FIG. 2 is a block diagram illustrating a display device 200 according to example embodiments. Depending on the embodiments, certain elements may be removed from or additional elements may be added to the display device 200 illustrated in FIG. 2. Furthermore, two or more elements may be combined into a single element, or a single element may be realized as multiple elements. This applies to the apparatus embodiments shown in FIGS. 8, 12, 14 and 15.

Referring to FIGS. 1 and 2, the display device 200 includes a display panel 210 and a driving integrated circuit (IC) 230. The display panel 210 may include a plurality of pixels 215 and 216 connected to a plurality of scan lines 221, 223 and 225. The display device 200 may be any display device, such as an organic light emitting diode (OLED) display device, a liquid crystal display (LCD) device, a plasma display panel (PDP) display device, etc. The display device 200 may be a display device employed in any electronic device, such as a cellular phone, a smart phone, a tablet computer, a wearable device, a personal digital assistant (PDA), a portable multimedia player (PMP), a digital camera, a music player, a portable game console, a navigation system, a digital television, a 3D television, a personal computer (PC), a home appliance, a laptop computer, etc.

FIG. 3 is a diagram illustrating frame periods of a display device according to example embodiments. The display device 200 according to example embodiments is a progressive type display device that sequentially drives the pixels 215 and 216 such that an image is sequentially displayed from the pixels 215 connected to the first scan line 221 to the pixels 216 connected to the last scan line 225. For example, as illustrated in FIG. 3, each of frames 300 of the display panel 200 includes a scan period and a display period, and each pixel 215 and 216 may display the image during the display period after the scan period. The pixels 215 and 216 may sequentially store data signals (e.g., data voltages or data currents) during the scan period on a scan line by scan line basis (or a row by row basis), and may sequentially display the image during the display period on the scan line by scan line basis (or the row by row basis). Thus, the pixels 215 and 216 may display the image at different time points according to positions (or rows) of the pixels 215 and 216, or according to the scan lines 221, 223 and 225 to which the pixels 215 and 216 are connected. For example, a time point T2 when the pixels 225 connected to the last scan line 225 start to display the image is delayed by about one frame period with respect to a time point T1 when the pixels 221 connected to the first scan line 221 start to display the image.

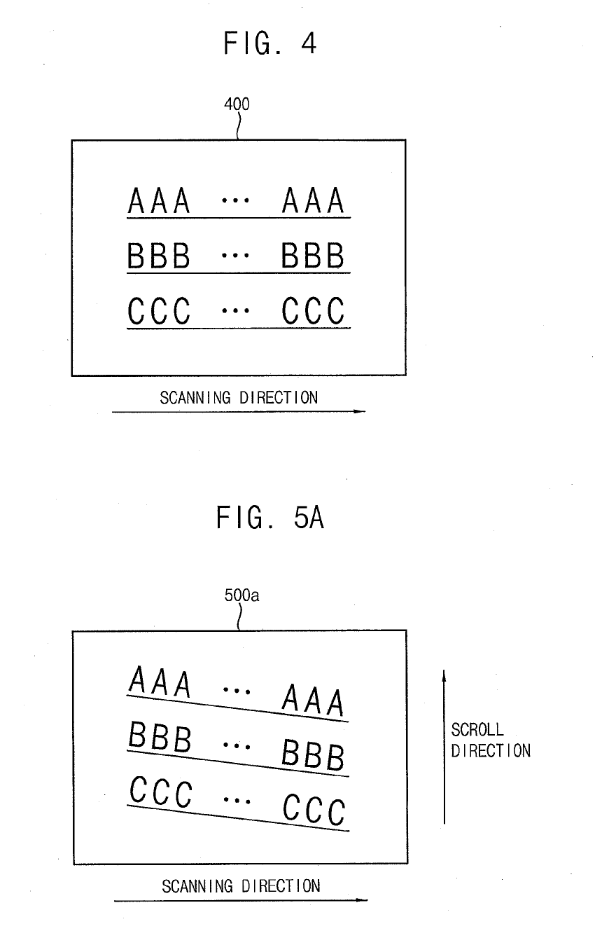

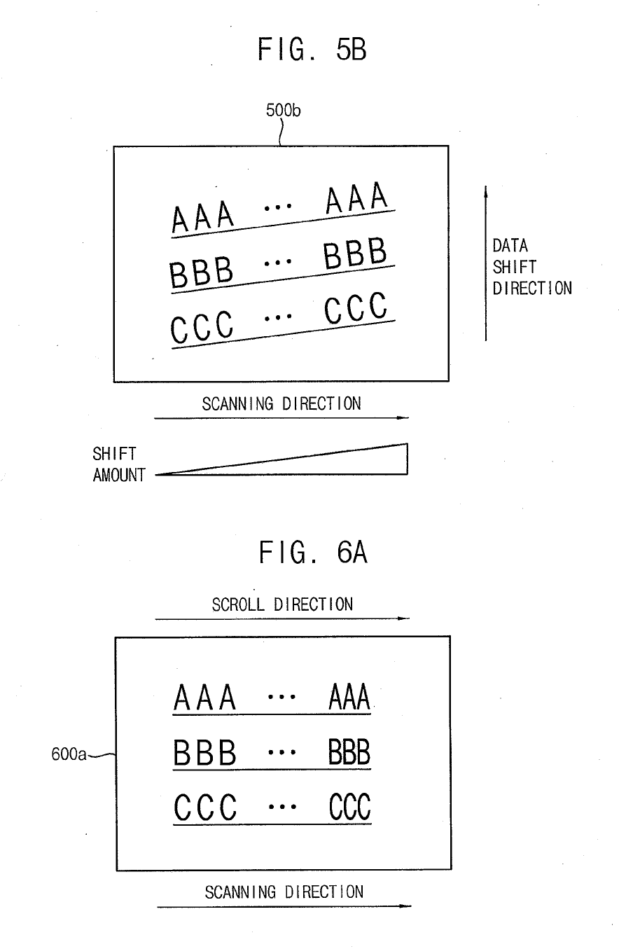

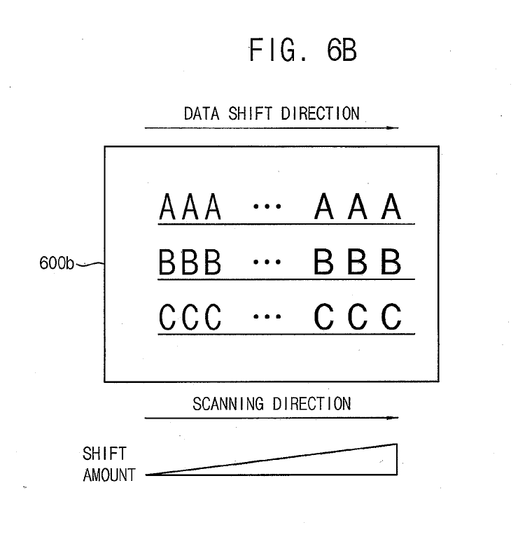

FIG. 4 is a diagram illustrating an example of a still image generated by a display device in accordance with example embodiments. FIG. 5A is a diagram for describing an example where an image distortion occurs in a typical display device when an image is scrolled, and FIG. 5B is a diagram for describing an example of a data shift operation performed by a display device according to example embodiments. FIG. 6A is a diagram for describing another example where image distortion occurs in a typical display device when an image is scrolled, and FIG. 6B is a diagram for describing another example of a data shift operation performed by a display device according to example embodiments.

In a typical progressive type display device (not necessarily prior art) that sequentially displays an image, an image distortion may occur while the image is scrolled. For example, in a case where, while a typical display device displays a still image 400 as illustrated in FIG. 4, the still image 400 is scrolled from bottom to top of a screen, as illustrated in FIG. 5A, a distorted image 500a where the image at the last scan line may be inclined toward a bottom side compared with the image at the first scan line may be perceived by a user. Since display start time points of respective pixels are sequentially delayed along a scanning direction, the typical display device may display the images of two different frames at any time point. Accordingly, the use may perceive that the movement of the image displayed by the pixels appears to be sequentially delayed on the scan line by scan line basis. Further, in a case where, while the typical display device displays the still image 400 as illustrated in FIG. 4, the still image 400 is scrolled from left to right of the screen, as illustrated in FIG. 6A, a distorted image 600a where the image at the last scan line may be reduced compared with the image at the first scan line may be perceived by a user.

In the method of compensating the image of the display device 200 that sequentially drives the plurality of pixels 215 and 216 in a scanning direction from a first scan line 221 to a second scan line 225 according to example embodiments, a scroll speed of the image displayed by the display device 200 may be obtained (S210). Here, the scroll speed may mean a distance where the image (or any point of the image) is moved per unit time (e.g., second) within the screen by the image scroll. Further, here, a scroll direction of the image may mean a direction in which the image (or any point of the image) is moved within the screen. For example, in a case where the display device 200 displaying an upper portion of a web page performs a scroll operation to display a lower portion of the web page, since any point of the image within the screen of the display device 200 is moved toward a top side of the screen, the scroll direction may be a direction from bottom to top of the screen.

Image data for the pixels 215 and 126 may be shifted by a shift amount that is substantially proportional to the scroll speed and gradually increases along the scanning direction (S130). For example, in a case where the scanning direction is from the first scan line 221 to the second scan line 225, the shift amount of the image data for the pixels 216 connected to the second scan line 225 is greater than the shift amount of the image data for the pixels 215 connected to the first scan line 221. Further, the image data may be shifted in a direction the same as the scanning direction.

For example, in a case where the image is scrolled from bottom to top of the screen as illustrated in FIG. 5A, the display device 200 may display a compensated image 500b that is shifted in a direction the same as the scanning direction, or a direction from bottom to top of the screen. Further, the display device 200 may shift the image data by the shift amount that is substantially proportional to the scroll speed and is gradually increased along the scanning direction. For example, the shift amount may be minimum with respect to the pixels 215 connected to the first scan line 221, may be increased per one or more scan lines, and may be maximum with respect to the pixels 216 connected to the last scan line 225. Further, for example, in a case where the scroll speed corresponds to 10 pixels per frame, or in a case where the image moves by a distance corresponding to 10 pixels during one frame period, the shift amount for the pixels 216 connected to the last scan line 225 may correspond to the number of pixels per frame, or the 10 pixels. In another example, in a case where the image is scrolled from left to right of the screen as illustrated in FIG. 6A, the display device 200 may display a compensated image 600b that is shifted in a direction the same as the scanning direction, or a direction from left to right of the screen. As described above, when the image is scrolled in the display device 200 according to example embodiments, the image data is shifted by the shift amount that is substantially proportional to the scroll speed and gradually increases along the scanning direction. Accordingly, in the display device 200 according to example embodiments, the image distortion caused by the image scroll may not be perceived by the user, and the undistorted image, such as the image 400 of FIG. 4, may be perceived by the user.

As described above, in the method of compensating the image of the display device 200 according to example embodiments, the image data may be shifted by the shift amount that is substantially proportional to the scroll speed and gradually increases along the scanning direction, and thus the image distortion caused by the image scroll may be prevented.

Although FIGS. 5A through 6B illustrate example embodiments where the entire image displayed by the display device 200 is shifted and the image data corresponding to the entire screen are shifted, the method of compensating the image according to example embodiments may be applied to example embodiments where a portion of the screen is scrolled and the image data corresponding to the portion of the screen are shifted.

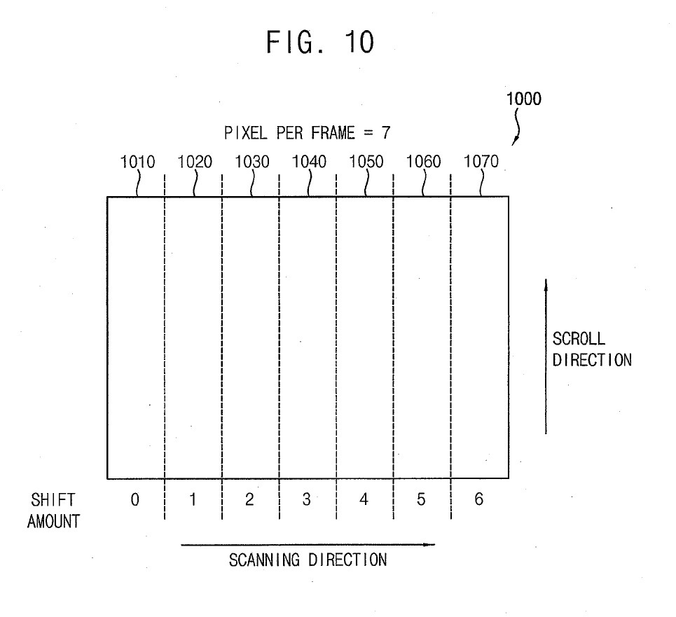

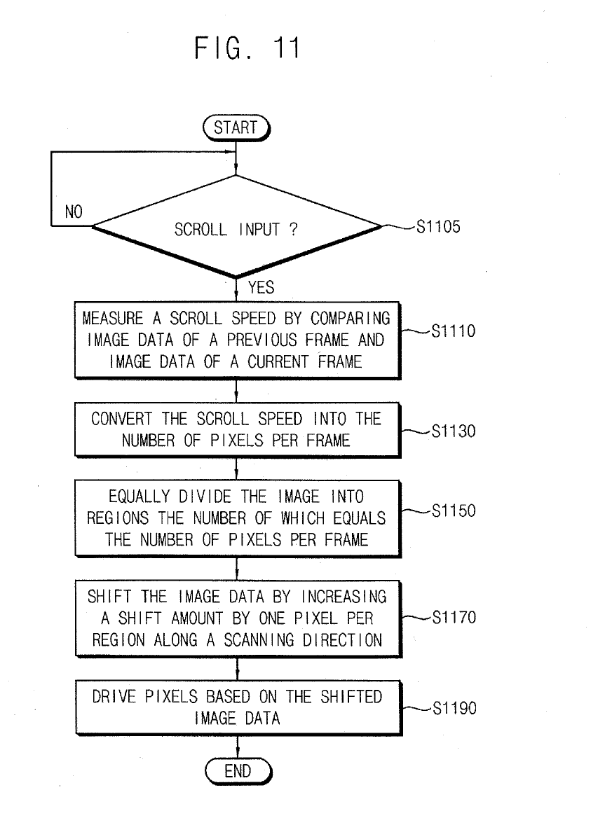

FIG. 7 is a flow chart illustrating a method of compensating an image of a display device according to example embodiments, FIG. 8 is a block diagram illustrating a display device 800 according to example embodiments, FIG. 9 is a diagram for describing a method of measuring a scroll speed in a display device according to example embodiments, and FIG. 10 is a diagram for describing an example of a data shift operation performed by a display device according to example embodiments.

Referring to FIGS. 7 and 8, the display device 800 includes a display panel 810 including a plurality of pixels 815, a scan driving unit or scan driver 820, a scroll speed measuring unit 840, a data shifting unit or data shifter 850 and a data driving unit or data driver 860. The scan driving unit 820 sequentially provides a scan signal to the pixels 815 in a scanning direction from a first scan line 821 to a second scan line 825. The scroll speed measuring unit 840 measures a scroll speed of an image displayed at the display panel 810. The data shifting unit 850 shifts image data for the pixels 815, and the data driving unit 860 drives the pixels 815 based on the shifted image data. In some example embodiments, the scan driving unit 820 is implemented by transistors directly formed on the display panel 810. In other example embodiments, the scan driving unit 820 is implemented within a driving IC 830 or another IC. The scroll speed measuring unit 840, the data shifting unit 850 and the data driving unit 860 may be implemented within the driving IC 830. Alternatively, at least a portion of the scroll speed measuring unit 840, the data shifting unit 850 and the data driving unit 860 may be implemented in another IC.

In the display device 800 that sequentially drives the pixels 815 in the scanning direction from the first scan line 821 to the second scan line 825, the scroll speed measuring unit 840 may measure the scroll speed of the image (S710). In some example embodiments, the scroll speed measuring unit 840 compares image data of a previous frame and image data of a current frame to measure the scroll speed. In an example illustrated in FIG. 9 where an object 915 in an image 910 of a previous frame is moved by a distance D in an image 920 of a current frame by the image scroll, the scroll speed measuring unit 840 may detect the movement distance D of the object 915 by comparing the image 910 of the previous frame and the image 920 of the current frame, and may measure the scroll speed by dividing the movement distance D by a time interval (e.g., a time length corresponding to one frame period) between the previous frame and the current frame.

The data shifting unit 850 may shift image data for the pixels 815 by a shift amount that is substantially proportional to the scroll speed and gradually increases along the scanning direction (S730, S750 and S770). Thus, the shift amount of the image data for the pixels 815 connected to the second scan line 825 may be greater than the shift amount of the image data for the pixels 815 connected to the first scan line 821. Further, the data shifting unit 850 may shift the image data in a direction the same as the scanning direction.

To perform this data shift operation, the data shifting unit 850 may convert the scroll speed of the image into the number of pixels per frame, or the number of pixels corresponding to the movement distance of the image during one frame period (S730), may equally divide the image displayed at the display panel 810 into a plurality of regions such that the number of the regions equals the number of pixels per frame (S750), and may shift the image data by increasing the shift amount by one pixel per each region along the scanning direction (S770).

For example, in a case where the movement distance D of the image in FIG. 9 corresponds to a length of 7 pixels, the image 1000 of the display panel 810 may be divided into 7 regions 1010, 1020, 1030, 1040, 1050, 1060 and 1070 as illustrated in FIG. 10. In this case, the data shifting unit 850 may increase the shift amount by one pixel per each of the regions 1010, 1020, 1030, 1040, 1050, 1060 and 1070 along the scanning direction. For example, the data shifting unit 850 may not shift the image data for a first region 1010, may shift the image data for a second region 1020 by the shift amount corresponding to one pixel, may shift the image data for a third region 1030 by the shift amount corresponding to two pixels, may shift the image data for a fourth region 1040 by the shift amount corresponding to three pixels, may shift the image data for a fifth region 1050 by the shift amount corresponding to four pixels, may shift the image data for a sixth region 1060 by the shift amount corresponding to five pixels, and may shift the image data for a seventh region 1070 by the shift amount corresponding to six pixels.

In another example, the image 1000 is divided such that the number of the regions is greater by one than the number of pixels per frame, and the shift amount for the last region may correspond to the pixels the number of which is the same as the number of pixels per frame.

Although an example where the data shifting unit 850 converts the scroll speed into the number of pixels per frame is described above, in some example embodiments, the scroll speed measuring unit 840 may convert the scroll speed into the number of pixels per frame. Alternatively, the scroll speed measuring unit 840 may measure the scroll speed in unit of the number of pixels per frame.

The data driving unit 860 may drive the pixels 815 based on the shifted image data (S790). Accordingly, an image that is shifted to compensate an image distortion caused by the image scroll may be displayed, and a user may perceive an undistorted image.

As described above, in the method of compensating the image of the display device 800 according to example embodiments, the scroll speed may be measured and converted into the number of pixels per frame, the image may be equally divided into the regions the number of which equals the number of pixels per frame, and the image data may be shifted by increasing the shift amount by one pixel per each region along the scanning direction. Accordingly, the image distortion caused by the image scroll may be prevented.

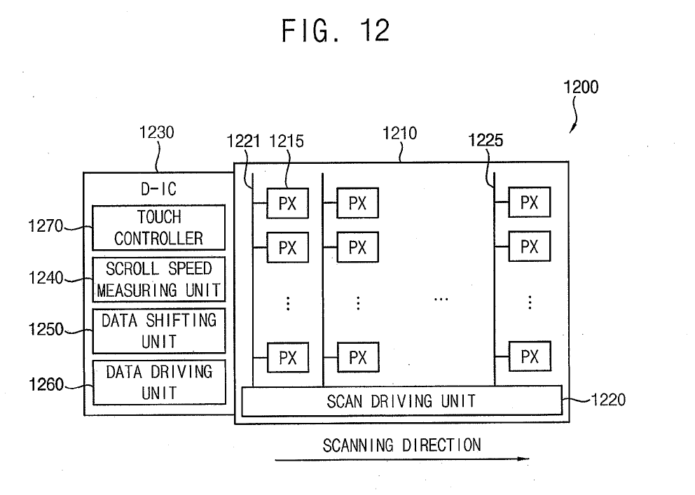

FIG. 11 is a flow chart illustrating a method of compensating an image of a display device according to example embodiments, and FIG. 12 is a block diagram illustrating a display device 1200 according to example embodiments.

Referring to FIGS. 11 and 12, the display device 1200 includes a display panel 1210 including a plurality of pixels 1215, a scan driving unit 1220 that sequentially provides a scan signal to the pixels 1215 in a scanning direction from a first scan line 1221 to a second scan line 1225, a scroll speed measuring unit 1240, a data shifting unit 1250, a data driving unit 1260, and a touch controller 1270. According to example embodiments, the touch controller 1270 may be within a driving IC 1230 or another IC. Compared with a display device 800 of FIG. 8, the display device 1200 of FIG. 12 may further include the touch controller 1270, and the display panel 1210 of FIG. 12 may further include touch sensors that detect a touch input by a user. Compared with a method illustrated in FIG. 7, a method of compensating an image illustrated in FIG. 11 may further include a step (S1105) of recognizing a scroll input by the user.

In the method of compensating the image of the display device 1200 according to example embodiments, the touch controller 1270 may recognize the scroll input by the user (S1105). For example, the touch controller 1270 may detect the touch input by the user by using the touch sensors included in the display panel 1210, and may provide a host device (e.g., an application processor) with data corresponding to the touch input. The touch controller 1270 may include a scroll recognizing unit that determines whether the touch input detected by the touch sensors corresponds to the scroll input. If the scroll recognizing unit decides the touch input detected by the touch sensors not to be the scroll input (S1105: NO), a data shift operation may not be performed. If the scroll recognizing unit decides the touch input detected by the touch sensors to be the scroll input (e.g., if the touch input is decided to be an input corresponding to dragging after touching) (S1105: YES), the touch controller 1270 may provide the scroll speed measuring unit 1240 with a scroll notification signal indicating to initiate a scroll speed measurement. In other example embodiments, the host device may determine whether the touch input corresponds to the scroll input, and the host device may provide the scroll speed measuring unit 1240 with the scroll notification signal indicating to initiate the scroll speed measurement.

The scroll speed measuring unit 1240 may measure a scroll speed of an image in response to the scroll notification signal provided from the touch controller 1270 (or from the host device) (S1110). In some example embodiments, the scroll speed measuring unit 1240 measures the scroll speed during a predetermined time (e.g., few seconds) from a time point when the scroll input is recognized. Thus, the scroll speed may be measured during a portion of an operating time of the display device 1200, thereby reducing power consumption for measuring the scroll speed.

The data shifting unit 1250 may convert the scroll speed of the image into the number of pixels per frame (S1130), may equally divide the image displayed at the display panel 1210 into a plurality of regions such that the number of the regions equals the number of pixels per frame (S1150), and may shift the image data by increasing the shift amount by one pixel per each region along the scanning direction (S1170). The data driving unit 1260 may drive the pixels 1215 based on the shifted image data (S1190). Accordingly, an image that is shifted to compensate an image distortion caused by the image scroll may be displayed, and a user may perceive an undistorted image.

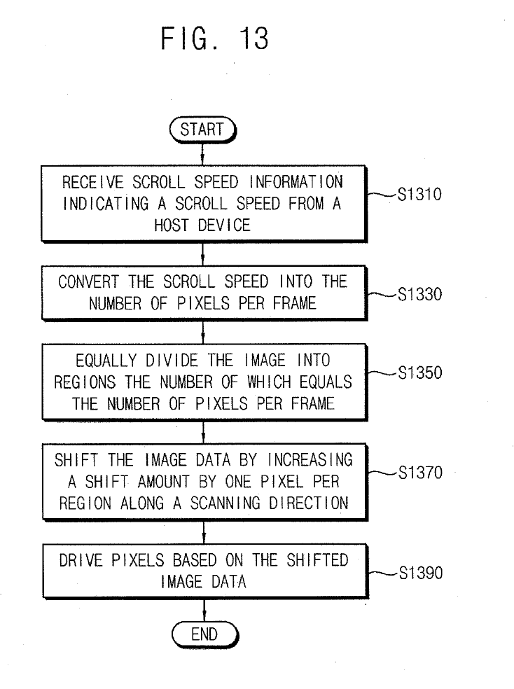

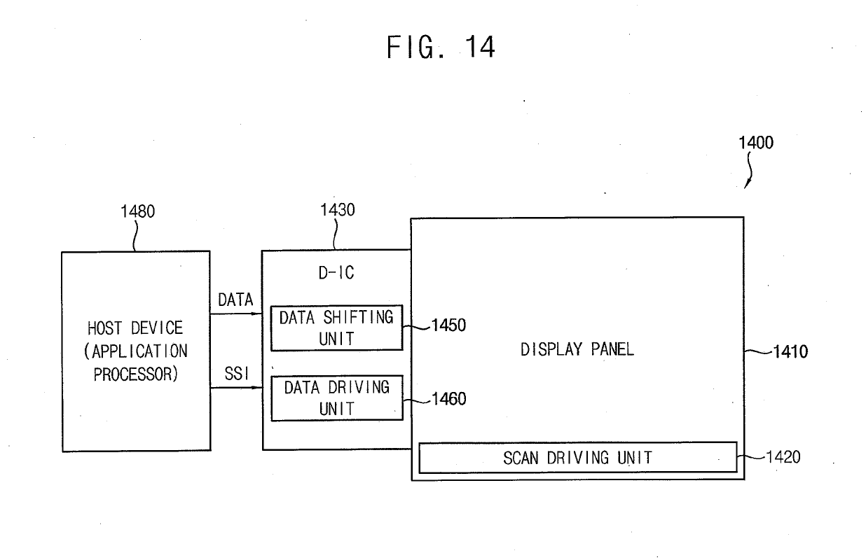

FIG. 13 is a flow chart illustrating a method of compensating an image of a display device according to example embodiments, and FIG. 14 is a block diagram illustrating a display device 1400 according to example embodiments.

Referring to FIGS. 13 and 14, the display device 1400 includes a display panel 1410, a scan driving unit 1420, a data shifting unit 1450 and a data driving unit 1460. In some example embodiments, the scan driving unit 1420 may be directly formed on the display panel 1410, and the data shifting unit 1450 and the data driving unit 1460 may be implemented within a driving IC 1430.

In a method of compensating an image of the display device 1400 according to example embodiments, the data shifting unit 1450 may receive, along with image data DATA, scroll speed information SSI representing a scroll speed of an image displayed at the display panel 1410 from a host device 1480 (e.g., an application processor) that controls the display device 1400 (S1310). The data shifting unit 1450 may convert the scroll speed indicated by scroll speed information SSI into the number of pixels per frame (S1330), may equally divide the image displayed at the display panel 1410 into a plurality of regions such that the number of the regions equals the number of pixels per frame (S1350), and may shift the image data DATA by increasing the shift amount by one pixel per each region along the scanning direction (S1370). The data driving unit 1460 may drive pixels based on the shifted image data (S1390). Accordingly, an image that is shifted to compensate an image distortion caused by the image scroll may be displayed, and a user may perceive an undistorted image.

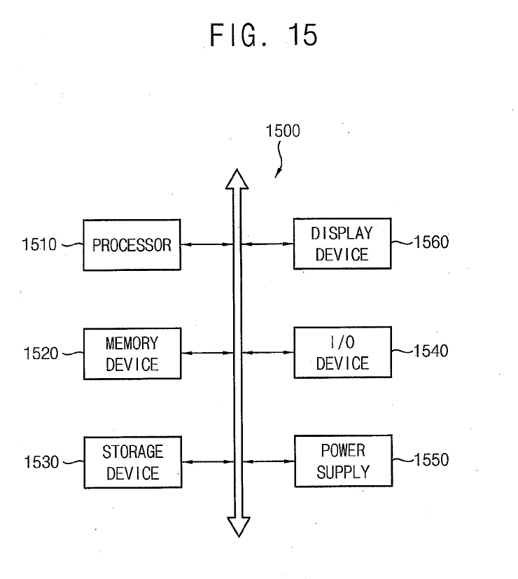

FIG. 15 is a block diagram illustrating an electronic device 1500 including a display device in accordance with example embodiments.

Referring to FIG. 15, the electronic device 1500 includes a processor 1510, a memory device 1520, a storage device 1530, an input/output (I/O) device 1540, a power supply 1550, and a display device 1560. The electronic device 1500 may further include a plurality of ports for communicating a video card, a sound card, a memory card, a universal serial bus (USB) device, other electric devices, etc.

The processor 1510 may perform various computing functions. The processor 1510 may be a microprocessor, a central processing unit (CPU), an application processor (AP), etc. The processor 1510 may be connected to other components via an address bus, a control bus, a data bus, etc. Further, in some example embodiments, the processor 1510 may be connected to an extended bus such as a peripheral component interconnection (PCI) bus.

The memory device 1520 may store data for operations of the electronic device 1500. For example, the memory device 1520 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc.

The storage device 1530 may be a solid state drive device, a hard disk drive device, a CD-ROM device, etc. The I/O device 1540 may be an input device such as a keyboard, a keypad, a mouse, a touch screen, etc., and an output device such as a printer, a speaker, etc. The power supply 1550 may supply power for operations of the electronic device 1500.

The display device 1560 may display an image based on image data provided by the processor 1510. In a case where a scroll operation is performed, the display device 1560 may shift image data by a shift amount in proportion to a scroll speed while gradually increasing the shift amount along a scanning direction. Accordingly, an image distortion caused by an image scroll may be prevented.

The described technology can be applied to any electronic device 1500 including the display device 1560, or other electronic devices such as a cellular phone, a smart phone, a tablet computer, a wearable device, a personal digital assistant (PDA), a portable multimedia player (PMP), a digital camera, a music player, a portable game console, a navigation system, a digital television, a 3D television, a personal computer (PC), a home appliance, a laptop computer, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of compensating an image on a display device, the method comprising:
obtaining a scroll speed of the image displayed by the display device that sequentially drives a plurality of pixels in a scanning direction from a first scan line to a second scan line; and
shifting image data for the pixels by a shift amount, the shift amount being substantially proportional to the scroll speed and gradually increasing along the scanning direction.

2. The method of claim 1, wherein the shift amount of the image data for a first group of the pixels connected to the first scan line is less than the shift amount of the image data for a second group of the pixels connected to the second scan line.

3. The method of claim 1, wherein the image data are shifted in a direction the same as the scanning direction.

4. The method of claim 1, further comprising converting the scroll speed of the image into a number of pixels per frame.

5. The method of claim 4, wherein the shift amount of the image data for a third group of the pixels connected to a last scan line corresponds to the number of pixels per frame.

6. The method of claim 4, wherein the shifting comprises:
equally dividing the image displayed in the display device into a plurality of regions such that the number of the regions equals the number of pixels per frame; and
increasing the shift amount by one pixel per each of the regions along the scanning direction so as to shift the image data.

7. The method of claim 1, wherein the scroll speed is measured by comparing the image data of a previous frame and the image data of a current frame.

8. The method of claim 1, further comprising recognizing a scroll input by a user.

9. The method of claim 8, wherein the scroll speed is measured during a predetermined time from a time point when the scroll input is recognized.

10. The method of claim 8, wherein the scroll input is recognized by a touch controller included in the display device.

11. The method of claim 1, wherein the scroll speed is obtained based on scroll speed information provided from a host device that controls the display device.

12. A display device, comprising:
a display panel including a plurality of pixels;
a scan driver configured to sequentially provide a scan signal to the pixels in a scanning direction from a first scan line to a second scan line;
a scroll speed measuring unit configured to measure a scroll speed of an image displayed in the display panel;
a data shifter configured to shift image data for the pixels by a shift amount, the shift amount being substantially proportional to the scroll speed and gradually increasing along the scanning direction; and
a data driver configured to drive the pixels based on the shifted image data.

13. The display device of claim 12, wherein the shift amount of the image data for a first group of the pixels connected to the first scan line is less than the shift amount of the image data for a second group of the pixels connected to the second scan line.

14. The display device of claim 12, wherein the scroll speed measuring unit is further configured to measure the scroll speed based on the comparison of the image data of a previous frame and the image data of a current frame.

15. The display device of claim 12, wherein the data shifter is further configured to shift the image data in a direction the same as the scanning direction.

16. The display device of claim 12, wherein the data shifter is further configured to i) convert the scroll speed of the image into a number of pixels per frame, ii) equally divide the image displayed in the display panel into a plurality of regions such that the number of the regions equals the number of pixels per frame, and iii) increase the shift amount by one pixel per each of the regions along the scanning direction so as to shift the image.

17. The display device of claim 12, further comprising:
a plurality of touch sensors configured to detect a touch input by a user; and
a touch controller configured to control the touch sensors, the touch controller including a scroll recognizer configured to determine whether the touch input detected by the touch sensors corresponds to a scroll input.

18. The display device of claim 17, wherein the scroll speed measuring unit is further configured to measure the scroll speed during a predetermined time from a time point when the scroll recognizer recognizes the scroll input.

19. The display device of claim 12, wherein the scroll speed measuring unit is further configured to initiate an operation that measures the scroll speed in response to a scroll notification signal received from a host device.

20. A display device, comprising:
a display panel including a plurality of pixels;
a scan driver configured to sequentially provide a scan signal to the pixels in a scanning direction from a first scan line to a second scan line;
a data shifter configured to receive scroll speed information representing a scroll speed of an image displayed in the display panel, and to shift image data for the pixels by a shift amount, the shift amount being substantially proportional to the scroll speed and gradually increasing along the scanning direction; and
a data driver configured to drive the pixels based on the shifted image data.
